(19) United States
(12) Patent Application Publication
(10) Pub. No.: US 2026/0098392 A1
(43) Pub. Date: Apr. 9, 2026

(54) TILTROTATOR ARRANGEMENT INCLUDING A TILTROTATOR AND A VALVE ARRANGEMENT

(71) Applicant: Rototilt Group AB, VINDELN (SE)

(72) Inventors: Niklas Bjuhr, VINDELN (SE); Johnny Holgersson, BJURHOLM (SE)

(21) Appl. No.: 19/417,452

(22) Filed: Dec. 12, 2025

Related U.S. Application Data
(63) Continuation of application No. PCT/SE2024/050662, filed on Jul. 3, 2024.

(30) Foreign Application Priority Data
Jul. 3, 2023 (SE) 2350831-0

(51) Int. Cl. E02F 3/36; E02F 3/43; F15B 15/26; F15B 19/00

(52) U.S. Cl. CPC E02F 3/3681; E02F 3/435; F15B 15/26; F15B 19/00

(57) ABSTRACT

A pressure monitoring system for a tiltrotator. The tiltrotator has a rotation motor, at least one tilting cylinder, a lower holder for holding a tool, a locking block for coupling a tool to the lower holder, a hydraulic cylinder for actuating the locking block between a closed and an open position, and a first valve for controlling the hydraulic cylinder to actuate the locking block between the closed and the open position. The pressure monitoring system includes: a pressure sensor for sensing a pressure in a hydraulic line between the first valve and a first pressure chamber of the hydraulic cylinder, a control unit configured to receive the sensed pressure from the pressure sensor and to verify that the first chamber of the hydraulic cylinder is pressurized to push the locking block towards the closed position based on the monitored pressure.

### TECHNICAL FIELD

The various embodiments of the invention relates to a tiltrotator comprising a pressure monitoring system. Specifically, embodiments of the invention relate to tiltrotator with a pressure monitoring system in which a pressure sensor is positioned to measure relevant operation pressures during different stages of the operation of the tiltrotator.

### BACKGROUND

In forestry, construction work and the like it has become more and more common to utilize a tiltrotator at the outer end of a working arm of a work vehicle, such as an excavator. The tiltrotator has a lower holder for carrying a tool such as a compactor, hydraulic hammer, grapple, bucket, etc. The tiltrotator simplifies the use of different tools as it is furnished with a hydraulic tool coupler for a simple change of tools and may provide both a tilting movement and an unlimited rotational movement of an attached tool. With a tiltrotator mounted on its arm the excavator becomes a more useful tool carrier in that the functionality of the tool is increased when mounted on a tiltrotator.

A tiltrotator is provided with pressurized hydraulic fluid from a hydraulic pressure source to drive the tilting motor, which is normally comprised of two hydraulic cylinders, and the rotation motor comprised in the tiltrotator. Further, a tiltrotator is provided with a hydraulic swivel so as to drive the functions of a hydraulic tool arranged below the tiltrotator. In a conventional tiltrotator a first pair of hydraulic lines through the swivel may be provided to drive a hydraulic cylinder arranged to lock the tool to a tool coupler arranged at the lower part of the tiltrotator. A second pair of lines through the swivel are often provided to drive a grapple module, which may be a complementary part of the tiltrotator. Further, a third pair of lines through the swivel is provided to drive a function of a tool arranged below the tiltrotator.

Nowadays it is common to exchange tools below the tiltrotator when different work operations are performed. During a normal work session several tool exchanges may be performed. A hydraulically maneuvered locking block is normally arranged to lock and unlock the tool coupled to the tiltrotator. It goes without saying that it is very important that such exchanges may be made in a safe manner, in which the operator will be able to easily confirm that a tool exchange has been successfully made and that the tool is correctly attached to the tool coupler of the tiltrotator.

Often, the locking block is biased towards the locked position such that it may end up in the locked position without that the operator has actively operated the locking block towards the locked position and without that the hydraulic cylinder controlling the locking block is pressurized towards the locked position. This results in a risk, because the operator may be led to believe that the locking block is secured in its position although it is not. This is especially risky if the locking block is provided with a position sensor arranged to provide a positive locking signal if the locking block is in its locking position.

In EP 2640 658 B1 a maneuvering device is disclosed in which sensors are arranged to verify a correct position of a working tool below a maneuvering device such as a tiltrotator. This invention has set a new standard for tiltrotators, and sensors are now implemented to verify a correct locked position of a working tool on most tiltrotators on the market.

It would be advantageous to achieve an arrangement where a sensor solution for a tiltrotator could be combined with additional functionality without compromising the high security provided by such a sensor solution.

### SUMMARY

According to a first aspect the invention relates to a tiltrotator comprising a pressure monitoring system for a tiltrotator, the tiltrotator further comprising:

a rotation motor,

at least one tilting cylinder,

a lower holder for holding a tool,

a locking block for coupling a tool to the lower holder,

a hydraulic cylinder for actuating the locking block between a closed and an open position, and

a first valve for controlling the hydraulic cylinder to actuate the locking block between the closed and the open position, wherein the pressure monitoring system of the tiltrotator comprises:

a pressure sensor for sensing a pressure in a hydraulic line between the first valve and a first pressure chamber of the hydraulic cylinder,

a control unit configured to receive the sensed pressure from the pressure sensor and to verify that the first chamber of the hydraulic cylinder is pressurized towards the closed position based on the monitored pressure.

An advantage of the inventive solution is that one sensor may be arranged to provide different functionalities, which conventionally would require the provision of at least two sensors arranged at different locations in the hydraulic system of the tiltrotator.

Specifically, the sensor may, due to its position in the hydraulic line between the first valve and a first pressure chamber of the hydraulic cylinder, a) verify a correct pressure at locking of a tool to the tool coupler of the tiltrotator, b) monitor the pressure during operation continuously or when desired, and c) when the locking cylinder is controlled to the open position of the locking block, monitor the return pressure.

In specific embodiments of the invention a position sensor is arranged to determine a position of the locking block and to send a signal to the control unit, the control unit being configured to verify that the that the locking block is in the closed position based on a signal from the position sensor and to provide a confirmation when the hydraulic cylinder is pressurized, and the locking block is in the closed position.

The position sensor provides, in combination with the pressure sensor, a strong and secure verification that the coupling to the tool is correct.

In embodiments of the invention the control unit is configured to issue a positive verification when the control unit has verified that the locking block is in the closed position based on a signal from the position sensor and that the hydraulic cylinder is pressurized towards the closed position based on the pressure sensed by the pressure sensor and/or to issue a negative verification when the control unit has not verified that the locking block is in the closed position based on a signal from the position sensor, or that the hydraulic cylinder is not pressurized towards the closed position based on the pressure sensed by the pressure sensor.

As an additional security function, the control unit may be connected to or form part of a controller of the work machine, such that the work machine and/or the tiltrotator may be prevented or at least limited from being moved and/or from performing specific tasks when a negative verification has been issued by the control unit and/or when no positive verification has been issued by the control unit.

In embodiments of the invention the pressure sensor is arranged to monitor the pressure provided to the tiltrotator during operation of the tiltrotator to verify that the hydraulic pressure provided to the tiltrotator is at a predetermined level, above a first threshold and below a second threshold.

This allows specific functionalities of the tiltrotator to be monitored during operation and provides a possibility, with the same sensor, to monitor the operation of the tiltrotator, at will and over time.

In embodiments of the invention the pressure sensor is arranged to sense a return pressure between the first valve and a first pressure chamber of the hydraulic locking cylinder of the tiltrotator when the first valve is positioned to control the hydraulic cylinder to actuate the locking block towards the open position and to send a signal thereof to the control unit, the control unit being configured to monitor the return pressure, specifically at installation of the tiltrotator.

The possibility to check the return pressure with a pressure sensor that is included in the system is helpful to verify a correct function of the tiltrotator.

In embodiments of the invention the pressure sensor is arranged to sense the hydraulic pressure in the system and to send a signal thereof to the control unit, the control unit being configured to monitor the hydraulic pressure in the system and to receive information regarding the position of a first control valve in the system for controlling a hydraulic function on or at the tiltrotator, and to monitor the hydraulic pressure in dependence of the position of at least one control valve, thereby enabling calibration of the at least one control valve.

The possibility to calibrate control valves of the tiltrotator with a pressure sensor that is included in the system is helpful to verify a correct function of the tiltrotators’ different hydraulic functions, internal and external.

In embodiments of the invention the pressure sensor is arranged in a hydraulic valve unit also comprising the first valve.

This offers a possibility to update an existing tiltrotator by arranging such a hydraulic valve unit with a pressure sensor.

In embodiments of the invention the hydraulic valve unit further comprises at least one other valve arranged to control a hydraulic function of the tiltrotator and/or a hydraulic function arranged on the tiltrotator, such as the rotation and the tilting of the tiltrotator.

Specifically, the hydraulic valve unit may include all or most of the valves involved in the tiltrotator system, including the valves controlling external functions, such as tools connected to or associated with the tiltrotator.

In embodiments of the invention, the locking block is biased towards the locked position.

Different embodiments of the invention are very useful for tiltrotators of this kind as they, for example, solve the problem of leaving the operator uncertain about the lock verification.

Other embodiments and advantages will be apparent from the detailed description and the appended drawings.

### BRIEF DESCRIPTION OF THE DRAWINGS

Below, specific embodiments of the invention will be described with reference to the appended drawings, of which:

FIG. 1 shows a work machine with a working arm on which a tiltrotator carrying a bucket is arranged,

FIG. 2 shows a closer view of the tiltrotator of FIG. 1,

FIG. 3 is a perspective view from above of a tiltrotator with a hydraulic valve unit,

FIG. 4 is a perspective view of the hydraulic valve unit shown in FIG. 3,

FIG. 5 is a perspective view from below of a tiltrotator with a grapple module,

FIG. 6 is a hydraulic schematic illustrating a first embodiment of the invention, and

FIG. 7 is a hydraulic schematic illustrating a second embodiment of the invention.

### DETAILED DESCRIPTION

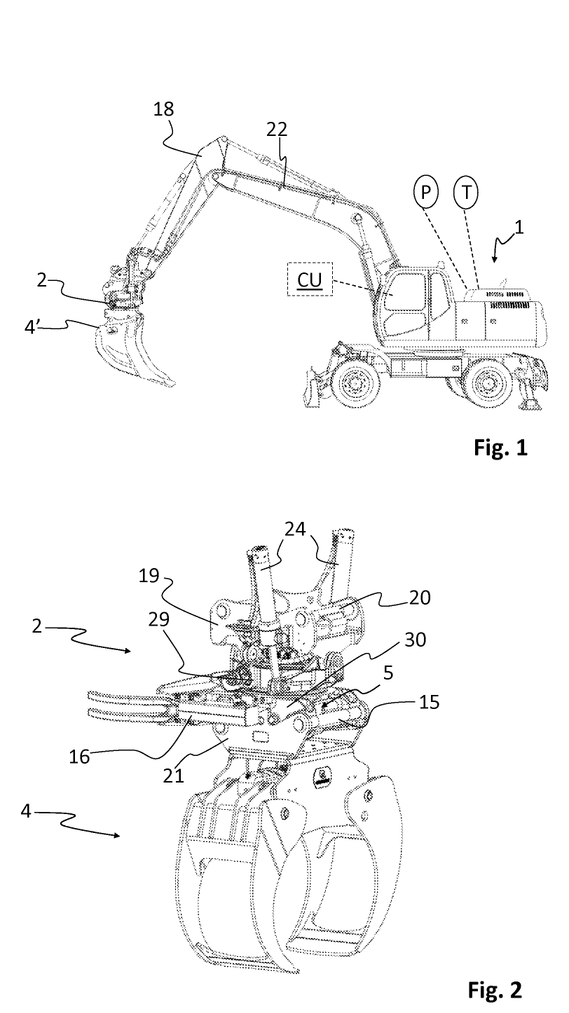

In FIG. 1 a work machine 1 with a working arm 18 is shown. At the outer end of the working arm 18 a tiltrotator 2 is arranged which carries a tool 4’, here in the form of a bucket. Hydraulic lines 22, typically in the form of pipes or hoses, are arranged along the working arm 18, one line from a pressure source P and one line for the return flow to a tank T, which are both arranged on the work machine 1. The tiltrotator 2 is arranged to carry both non-hydraulic tools like the bucket 4’ shown in FIG. 1 and hydraulic tools in need of hydraulic fluid to function.

In FIG. 2, a disconnected tiltrotator 2 carrying a hydraulic tool 4 in the form of a grapple is shown. The tiltrotator 2 comprises a coupling unit 19 at its very upper end for connection to a tool coupler provided on an outer end of a crane arm of a working machine as illustrated in FIG. 1. A tilting motor 24 in the form of two hydraulic cylinders are arranged at an upper part 29 of the tiltrotator 2.

There are also tiltrotators on the market not provided with a coupling unit, which are configured to be fixedly attached to the working arm of the work machine.

A lower part 30 of the tiltrotator 2 is rotatably arranged with respect to the upper part 29 of the tiltrotator 2. The lower part 30 of the tiltrotator 2 comprises a tool coupler 5 for attachment of the hydraulic tool 4, the hydraulic tool 4 comprising a coupling unit 21 with coupling pinas 15 arranged to be attached to the tool coupler 5. In the shown embodiment a grapple module 16 is arranged on the lower part 30 the tiltrotator 2. Both the hydraulic tool 4 and the grapple module 16 are hydraulically driven and are fed with hydraulic fluid via the tiltrotator 2.

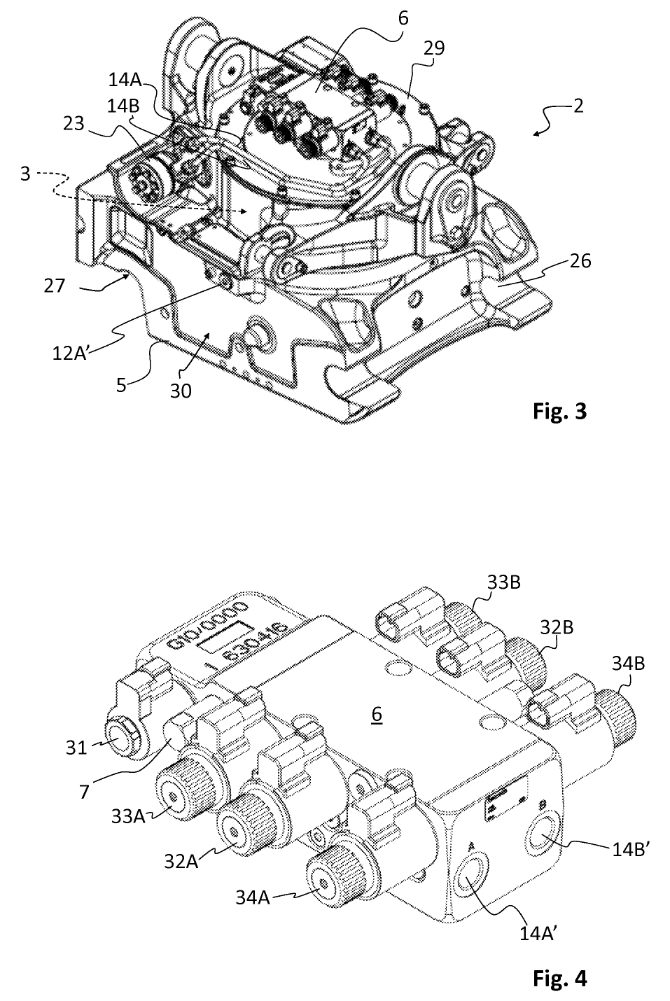

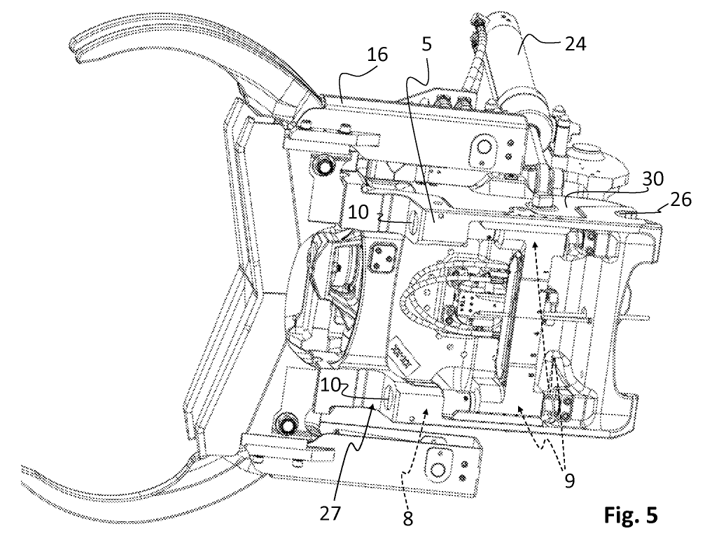

FIG. 3 is a perspective view of tiltrotator 2, without a connected tool, from above. The coupling unit 19 on the upper part 29 of the tiltrotator 2 typically comprising two pins, which in use are attached to a working arm, and the first and second coupling points 26 and 27 on the lower part 30 the tiltrotator 2 are coupled to a coupling unit of a tool. Typically, both the first and second coupling points 26 and 27 are comprised of recesses configured to receive coupling pins of a tool, which are similar to coupling unit 19 of the tiltrotator. The first coupling point 26 may comprise a hook on which a first coupling pin of a tool is to be received. The second coupling point 27 is preferably provided with a locking block (See FIG. 5) for securing a tool to the tool coupler 5 in conventional manner.

A hydraulic valve unit 6 is arranged at the upper part 29 of the tiltrotator 2, i.e. on the upstream side of the swivel 3. The hydraulic valve unit 6 is connected to the hydraulic pressure source P and to the tank T via separate lines 22 as illustrated in FIG. 1.

The hydraulic valve unit 6 is arranged to selectively connect the flow of pressurized hydraulic flow from the pressure source P to different hydraulic functions arranged on and below the tiltrotator 2. The tiltrotator 2 comprises a hydraulic swivel 3 for conveying hydraulic fluid from the hydraulic valve unit 6 to the lower part 30 of the tiltrotator 2.

The hydraulic swivel 3 is contained inside the tiltrotator 2 and is schematically illustrated in FIG. 3 although it is not visible from outside of the tiltrotator 2. The hydraulic swivel 3 comprises a plurality of lines for conveying hydraulic fluid in both directions over the rotation interface between the upper part 29 and the lower part 30 of the tiltrotator 2.

The connection ports to the lines of the valves inside the hydraulic valve unit 6 are arranged on the lower side of the valve unit 6 facing the upper part 29 of the tiltrotator 2 to pass through the swivel 3 to the lower part 30 of the tiltrotator 2 and hence these connection ports are not visible in FIG. 3. A hydraulic tool connection 12A’ that is supplied via the hydraulic valve unit 6 and the swivel 3 is provided on the outside of the lower part 30 of the tiltrotator 2.

Lines 14A and 14B are arranged from the valve in the hydraulic valve unit 6 controlling a rotation motor 23 arranged to provide the rotation between the upper part 29 and the lower part 30 of the tiltrotator 2. These lines 14A and 14B need not be provided through the swivel as the rotation motor 23 may be driven from above the swivel 3.

The hydraulic valve unit 6 is illustrated in a perspective view in FIG. 4. The hydraulic valve unit 6 comprises valves which may be controlled between a rest position and two active positions by dedicated valve actuators 32A-32B, 33A-33B, and 34A-34B that control the respective valve slides. Further, a first valve 31 is arranged, which has an open rest position providing a hydraulic pressure to close a locking block 10 of the tool coupler 5, and an active position in which the valve is positioned to allow the locking block 10 of the tool coupler 5 to move towards a closed position, as will be further described below.

The connections 14A’ and 14B’ are dedicated to the rotation motor 23 of the tiltrotator, via the lines 14A and 14B as illustrated in FIG. 3.

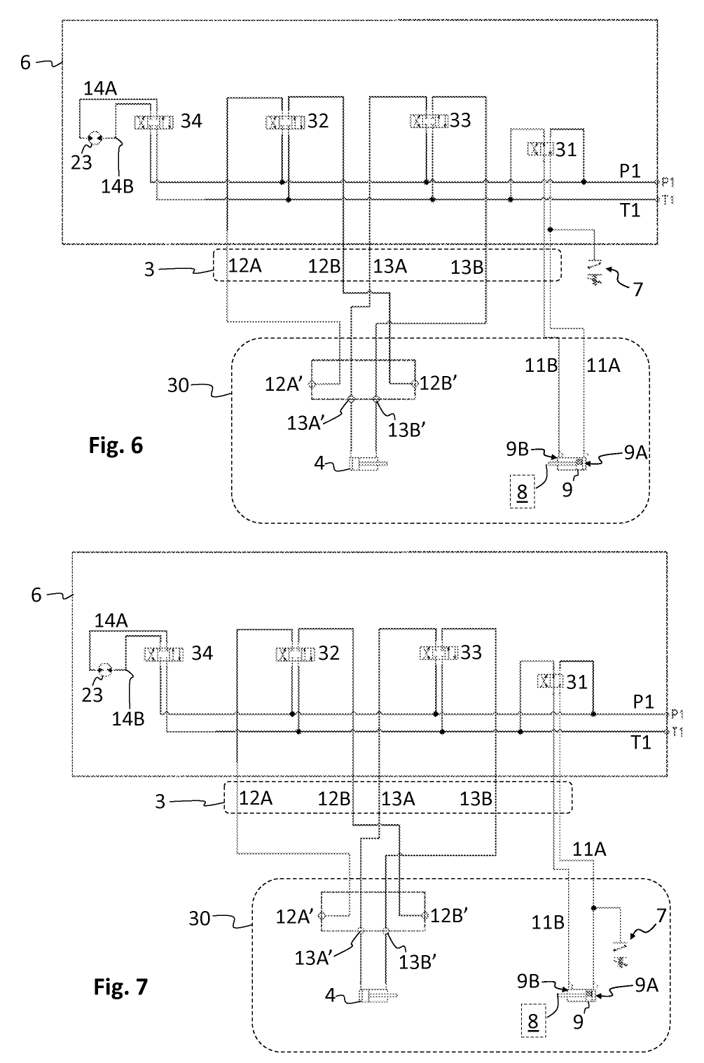

The hydraulic valve unit 6 may further contain a pressure sensor 7, which will be further described below with reference to FIG. 6.

In FIG. 5 a tiltrotator 2 with a grapple module 16 is shown from below. Also visible is the tilting motor 24 comprised of two hydraulic cylinders (only one is visible in FIG. 5) for providing a tilting movement of the tiltrotator 2, as well as an arrangement comprising at least one hydraulic cylinder 9 for achieving a locking of a hydraulic tool to the tool coupler 5. In the shown embodiment, two hydraulic cylinders 9 are arranged to drive a locking block 10, typically comprised of a pair of locking wedges, between a locking position and an unlocking position. Specifically, the hydraulic cylinders 9 are arranged in line with the locking wedges of the locking block 10, such that they are not visible in the drawing. The positions of the two hydraulic cylinders are indicated by the broken arrows 9. The locking block 10 is arranged to provide a locking function at the second coupling point 27 of the tool coupler 5.

The wedges of the locking block 10 are preferably shaped to mate with the cylindrical shape of a coupling pin of a coupling unit on a tool to be attached to the tiltrotator. In FIG. 5, the locking wedges of the locking block 10 are shown in the unlocking position. In the locking position, the locking wedges will extend out from their respective opening and block a second axial pin of a tool connector. When a tool is connected to the tool coupler 5, a first axial pin of the tool is arranged to be received in the first coupling point 26 of the tool coupler 5, wherein, subsequently, a second axial pin is arranged to be received in the second coupling point 27, after which the locking block 10 may be actuated to secure the tool to the tool coupler 5 of the tiltrotator 2. Also, not shown in the drawings, a spring element may be arranged to act on the wedges of the locking block 10 towards the locking position.

A position sensor 8 at the lower holder may be arranged to determine the position of the locking block 10 and to send a signal to a control unit CU of the tiltrotator or the working machine. The sensor may be any type of sensor capable of directly or indirectly verifying the position of the locking block 10 of the tiltrotator. This type of sensor may be configured to provide a signal indicating that the wedges of the locking block 10 are in position, regardless of if they have been pushed to this position by means of the hydraulic cylinder, or if the action of the spring has been enough to push them into locking position.

Sensors may also be arranged to detect the presence of one or both of the coupling pins of the tool.

FIG. 6 is a hydraulic schematic over the hydraulic valve unit 6, the tiltrotator 2, and the hydraulic functions connected to the tiltrotator 2.

In the embodiment shown in FIG. 6 the hydraulic valve unit 6 comprises four different valves 31-34. This is however a simplification provided to illustrate the functions of the invention. Other embodiments, with more or fewer valves, are conceivable within the scope of the invention. For instance, the tilting cylinders or a valve for regulating the tilting cylinders are not illustrated in FIG. 6.

A, first valve 31 is arranged to feed a hydraulic cylinder 9 arranged for locking and unlocking a hydraulic tool 4 to the tool coupler 5 arranged at the lower part 30 of the tiltrotator 2.

In the shown embodiment a second valve 32 is arranged to provide pressurized hydraulic fluid to a first hydraulic function and a third valve 33 is arranged to provide a second hydraulic function with pressurized hydraulic fluid, both hydraulic functions being double acting functions arranged at the lower part 30 of the tiltrotator 2, i.e., downstream of the hydraulic swivel 3.

In the shown embodiment, the second hydraulic function is used for the hydraulic tool 4, implying that the hydraulic tool 4 has a hydraulic consumer, such as a hydraulic cylinder, which is connected to connections 13A’ and 13B’.

The first hydraulic function is not utilized in the shown embodiment, such that connections 12A’ and 12B’ remain uncoupled. Often these connections are used for a grapple module 16 as is illustrated in FIG. 5.

A fourth valve 34 is arranged in the first valve unit 6 to feed the inherent rotation motor 23 of the tiltrotator. The rotation of the rotation motor 23 is preferably driven from the upstream side of the tiltrotator 2 such that the lines 14A and 14B, respectively, feeding the rotation motor 23 in opposite directions need not pass through the swivel 3 of the tiltrotator 2.

A fifth valve (not shown) may be arranged to feed the hydraulic tilting cylinder 24 of the tiltrotator 2. The hydraulic tilting cylinder 24 may be comprised of two double-acting hydraulic cylinders, as shown in FIG. 2, both hydraulic cylinders preferably being fed by the same fifth valve. The hydraulic tilting cylinder 24 is also arranged on the upper part 29 of the tiltrotator 2 and need not be fed via the swivel 3.

As is illustrated in the hydraulic schematic of FIG. 6 the hydraulic swivel 3 allows swiveled passage for a first pair of swivel lines 11A, 11B for feeding the hydraulic cylinder 9 arranged to drive a locking block (not shown), typically in the form of two locking wedges, for locking and unlocking the hydraulic tool 4 arranged at the lower part 30 of the tiltrotator 2 to the tool coupler 5.

The first swivel line 11A of the first pair of swivel lines 11A, 11B is connected to a first pressure chamber 9A of the hydraulic cylinder 9, i.e., the chamber of the hydraulic cylinder that pushes the locking block towards its closed position, and the second swivel line 11B of the first pair of swivel lines 11A, 11B is connected to the opposite second chamber 9B, which may be actuated to push the locking block 10 to the open position.

The swivel 3 further allows a swiveled passage of a second pair of swivel lines 12A, 12B and a third pair of swivel lines 13A, 13B for conveying hydraulic fluid between the upper part 29 of the tiltrotator 2 and the lower part 30 thereof.

The second valve 32 of the valve arrangement is arranged to connect the pressure line P1, emanating from the pressure source P, to a first hydraulic function connectable to the connections 12A’ and 12B’ at the lower part 30 of the tiltrotator 2, by providing a first feed flow to the lower part 30 of the tiltrotator 2 via either the first line 12A or the second line 12B of the second pair of swivel lines 12A, 12B to the hydraulic function.

The third valve 33 of the valve arrangement is, in a corresponding manner as the second valve 32, arranged to connect the pressure line P1, emanating from the pressure source P, to a first hydraulic function at the lower part 30 of the tiltrotator 2, by providing a first feed flow to the lower part 30 of the tiltrotator 2 via either a first line 13A or a second line 13B of a third pair of swivel lines 13A, 13B to the hydraulic function 4, and simultaneously connect the other line of the third pair of swivel lines 13A, 13B to the tank line T1 leading to the tank T.

Both the second and the third valve 32 and 33, respectively, may also be controlled to a rest position to stop the flow and thereby keep the respective hydraulic function at rest. When the hydraulic functions comprise a double acting hydraulic function such as a hydraulic cylinder, the second and the third valves 32 and 33 will hence control the operation of these hydraulic functions, and in which direction hydraulic functions will operate.

The first valve 31 of the valve arrangement is arranged to connect the pressure line P1 to the locking hydraulic cylinder 9, by providing a first feed flow to the lower part 30 of the tiltrotator 2 via either the first line 11A or the second line 11B of the first pair of swivel lines 11A, 11B to the hydraulic cylinder 9 for locking and unlocking a hydraulic tool 4 to the tool coupler 5 arranged at the lower part of the tiltrotator 2. The first valve 31 provides a continuous pressure P’ to the first pressure chamber 9A of the hydraulic cylinder 9 when in its rest position, keeping the locking block 10 in its closed position. The valve needs to be actuated to leave this position and instead feed a pressure P’ to the second pressure chamber 9B of the hydraulic cylinder 9.

Below, aspects of the pressure monitoring system of the tiltrotator 2 will be described.

A pressure sensor 7 is arranged for sensing the pressure P’ along the hydraulic line 11A between the third valve 33 and the first pressure chamber 9A of the hydraulic cylinder 9. The pressure sensor 7 is configured to monitor the pressure P’ in the hydraulic line 11A and to communicate the monitored pressure to a control unit CU, which is provided in the work machine 1 as illustrated in FIG. 1.

The control unit CU is hence configured to receive the sensed pressure P’ from the pressure sensor 7. Based on this sensed pressure P’, the control unit CU is configured to verify that the first chamber 9A of the hydraulic cylinder 9 is pressurized towards the closed position.

Further, as illustrated in FIG. 5, a position sensor 8 may be arranged at the lower holder to determine the position of the locking block 10 and to send a signal to the control unit CU, the control unit CU being configured to verify that the that the locking block 10 is in the closed position based on a signal from the position sensor and to provide confirmation when the first pressure chamber 9A of the hydraulic cylinder 9 is pressurized and the locking block 10 is in the closed position.

The control unit CU is configured to issue a positive verification when the control unit CU has verified that the locking block 10 is in the closed position based on a signal from the position sensor 8 and that the hydraulic cylinder 6 is pressurized towards the closed position based on the pressure sensed by the pressure sensor 7.

The control unit CU may also be configured to issue a negative verification when the control unit CU has not verified that the that the locking block 10 is in the closed position based on a signal from the position sensor, or that the hydraulic cylinder is not pressurized towards the closed position based on the pressure sensed by the pressure sensor.

The control unit CU may be connected to or form part of a controller of the work machine 1, such that the work machine 1 and/or the tiltrotator 2 may be prevented or at least limited from being moved and/or from performing specific tasks when a negative verification has been issued by the control unit CU and/or when no positive verification has been issued by the control unit CU.

Also, the negative and/or positive verification may be issued to an operator of the tiltrotator to alert the operator that the coupling is correct or not.

The pressure sensor 7 is further arranged to monitor the pressure provided to the tiltrotator 2 to verify that the hydraulic pressure provided to the tiltrotator is at a predetermined level, i.e., within a specific range. Specifically, the hydraulic pressure should be above a first threshold T1 and below a second threshold T2. This will enable a monitoring of the hydraulic pressure over time and to provide a warning or to limit or stop handling of the work machine, tiltrotator, or tools connected to the tiltrotator if the hydraulic pressure is not within the specific range.

Also, the monitored hydraulic pressure P’ may be used for service purposes or to analyze the operation of the tiltrotator when the function of the tiltrotator is to be looked over, for instance when there are indications of malfunction.

The pressure sensor 7 is also arranged to sense a return pressure between the first valve 31 and the first pressure chamber 9A of the hydraulic cylinder 9 of the tiltrotator 2 when the first valve 31 is positioned to control the hydraulic cylinder 9 to actuate the locking block 10 towards the open position and to send a signal thereof to the control unit CU. The control unit CU being configured to monitor the return pressure, specifically at installation of the tiltrotator 2.

The return pressure sensed by the pressure sensor 7 is the overall return pressure of the hydraulic system.

Namely, the return pressure is system specific, such that if a return pressure that is higher than what is normal, e.g., over a specific return pressure threshold T3, this is an indication that something is not optimized in the system. Furthermore, the monitored return pressure will normally be the same throughout the lifetime of the tiltrotator, or possibly increase during the lifetime of the tiltrotator 2. Therefore, the possibility to check the return pressure with a pressure sensor 7 that is included in the system is helpful to verify a correct function of the tiltrotator 2.

The pressure sensor 7 is arranged to sense the hydraulic pressure in the system and to send a signal thereof to the control unit CU, the control unit being configured to monitor the hydraulic pressure in the system and to receive information regarding the position of a first control valve 12 in the system for controlling a hydraulic function on or at the tiltrotator, and to monitor the hydraulic pressure in dependence of the position of at least one control valve, thereby enabling calibration of the at least one control valve.

In view of the pressure sensor 7, in operation, being connected to the pressure line P1, it will continuously monitor the pressure in the pressure line. This pressure will vary as the other valves in the system, i.e., the second valve 32, the third valve 33 and the fourth valve 34, are actuated. Also, the pressure sensed by the pressure sensor will also be the same as the pressure provided via the respective valve 32, 33 and 34 at the specific instant. Therefore, the pressure sensor may be utilized to calibrate the second valve 32, the third valve 33 and the fourth valve 34 to make sure that at a specific maneuvering position the valves will provide a correct pressure. The calibration will also involve the control of the pressure provided from the pressure source P of the work machine 1.

Namely, the pressure provided from the pressure source P of the work machine 1 is dependent on the maneuvering of the valves and will be adapted to meet the pressure required by the hydraulic function controlled by the respective valve 32, 33 and 34 at the specific instant.

In the embodiment shown in FIG. 6 the pressure sensor 7 is arranged in, or in connection to, the hydraulic valve unit 6 along a portion of the first line 11A of the first pair of swivel lines 11A, 11B to the hydraulic cylinder 9.

In the embodiment shown in FIG. 7 the pressure sensor 7 is instead arranged at the lower holder 5 close to the hydraulic cylinder 9, along the first line 11A of the first pair of swivel lines 11A, 11B to the hydraulic cylinder 9, or at the entry of the first line 11A to the first pressure chamber 9A of the hydraulic cylinder 9.

Above, the invention has been described with reference to specific embodiments. The invention is, however, not limited to these embodiments. It is obvious to a person skilled in the art that other embodiments are possible within the scope of the following claims.

1. A tiltrotator comprising a pressure monitoring system, the tiltrotator further comprising:
a rotation motor,
at least one tilting cylinder,
a lower holder for holding a tool,
a locking block for coupling a tool to the lower holder,
a hydraulic cylinder for actuating the locking block between a closed and an open position, and
a first valve for controlling the hydraulic cylinder to actuate the locking block between the closed and the open position;
wherein the pressure monitoring system comprises:
a pressure sensor for sensing a pressure in a hydraulic line between the first valve and a first pressure chamber of the hydraulic cylinder,
a control unit configured to receive the sensed pressure from the pressure sensor and to verify that the first chamber of the hydraulic cylinder is pressurized to push the locking block towards the closed position based on the monitored pressure, wherein the pressure monitoring system further comprises a position sensor arranged to determine a position of the locking block and to send a signal to the control unit, the control unit being configured to verify that the locking block is in the closed position based on a signal from the position sensor and to provide a confirmation when the first chamber of the hydraulic cylinder is pressurized and the locking block is in the closed position.

2. The tiltrotator of claim 1, wherein the control unit is configured to issue a positive verification when the control unit has verified that the locking block is in the closed position based on a signal from the position sensor and that the first chamber of the hydraulic cylinder is pressurized towards the closed position based on the pressure sensed by the pressure sensor and/or to issue a negative verification when the control unit has not verified that the locking block is in the closed position based on a signal from the position sensor, or that the hydraulic cylinder is not pressurized towards the closed position based on the pressure sensed by the pressure sensor.

3. The tiltrotator of claim 2, wherein the control unit may be connected to or form part of a controller of the work machine 1, such that the work machine 1 and/or the tiltrotator 2 may be prevented or at least limited from being moved and/or from performing specific tasks when a negative verification has been issued by the control unit and/or when no positive verification has been issued by the control unit.

4. The tiltrotator of claim 1, wherein the pressure sensor is arranged to monitor the pressure provided to the tiltrotator during operation of the tiltrotator to verify that the hydraulic pressure provided to the tiltrotator is at a predetermined level, above a first threshold and below a second threshold.

5. The tiltrotator of claim 1, wherein the pressure sensor is arranged to sense a return pressure between the first valve and the first pressure chamber of the hydraulic cylinder when the first valve is positioned to control the hydraulic cylinder to actuate the locking block towards the open position and to send a signal thereof to the control unit, the control unit being configured to monitor the return pressure.

6. The tiltrotator of claim 1, wherein the pressure sensor is arranged to sense the hydraulic pressure in the system and to send a signal thereof to the control unit, the control unit being configured to monitor the hydraulic pressure in the system and to receive information regarding the position of a first control valve in the system for controlling a hydraulic function on or at the tiltrotator, and to monitor the hydraulic pressure in dependence of the position of at least one control valve, thereby enabling calibration the at least one control valve.

7. The tiltrotator of claim 1, wherein the pressure sensor is arranged in a hydraulic valve unit also comprising the first valve.

8. The tiltrotator of claim 7, wherein the hydraulic valve unit further comprises at least one other valve arranged to control a hydraulic function of the tiltrotator and/or a hydraulic function arranged on the tiltrotator.

9. The tiltrotator of claim 1, wherein the pressure sensor is arranged at the first pressure chamber of the hydraulic cylinder.

10. The tiltrotator of claim 1, wherein the locking block is biased towards the locked position.
